(19) United States
(12) Patent Application Publication
(10) Pub. No.: US 2024/0107519 A1
(43) Pub. Date: Mar. 28, 2024

(54) PER-PANEL PTRS DENSITY FOR UE COOPERATION

(71) Applicant: QUALCOMM Incorporated, San Diego, CA (US)

(72) Inventors: Mostafa KHOSHNEVISAN, San Diego, CA (US); Tao LUO, San Diego, CA (US); Peter GAAL, San Diego, CA (US)

(21) Appl. No.: 17/934,531

(22) Filed: Sep. 22, 2022

(51) Int. Cl. H04W 72/12; H04L 1/00; H04L 5/00

(52) U.S. Cl. CPC H04W 72/1268; H04L 1/0003; H04L 5/0051; H04W 72/1273; H04W 72/1289

(57) ABSTRACT

Apparatuses and methods for per-panel PTRS density for panels/sets of antennas of UEs are described. An apparatus is configured to transmit information associated with a PTRS density for each panel of a set of panels associated with the UE; receive, from a network entity, a configuration associated with the PTRS density for each panel of the set of panels; and communicate, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. Another apparatus is configured to receive the information, generate and transmit the configuration, and also to communicate via the PDSCH/PUSCH.

### TECHNICAL FIELD

The present disclosure relates generally to communication systems, and more particularly, to wireless communications utilizing phase tracking reference signal (PTRS) density.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus is configured to transmit information associated with a phase tracking reference signal (PTRS) density for each panel of a set of panels associated with the UE. The apparatus is also configured to receive, from a network entity, a configuration associated with the PTRS density for each panel of the set of panels. The apparatus is further configured to communicate, based on the configuration, downlink data via a physical downlink shared channel (PDSCH) or uplink data via a physical uplink shared channel (PUSCH) based on the PTRS density for one panel in the set of panels, where the PTRS density for the one panel of the set of panels is based on at least one of a modulation and coding scheme (MCS) or a number of scheduled resource blocks (RBs) associated with a PDSCH reception or PUSCH transmission through the one panel.

In the aspect, the method includes transmitting information associated with a phase tracking reference signal (PTRS) density for each panel of a set of panels associated with the UE. The method also includes receiving, from a network entity, a configuration associated with the PTRS density for each panel of the set of panels. The method further includes communicating, based on the configuration, downlink data via a physical downlink shared channel (PDSCH) or uplink data via a physical uplink shared channel (PUSCH) based on the PTRS density for one panel in the set of panels, where the PTRS density for the one panel of the set of panels is based on at least one of a modulation and coding scheme (MCS) or a number of scheduled resource blocks (RBs) associated with a PDSCH reception or PUSCH transmission through the one panel.

In another aspect of the disclosure, a method, a computer-readable medium, and an apparatus are provided for wireless communication at a network node. The apparatus is configured to receive, from a user equipment (UE), information associated with a phase tracking reference signal (PTRS) density for each panel of a set of panels associated with the UE. The apparatus is also configured to transmit, for the UE, a configuration associated with the PTRS density for each panel of the set of panels. The apparatus is further configured to communicate with the UE, based on the configuration, downlink data via a physical downlink shared channel (PDSCH) or uplink data via a physical uplink shared channel (PUSCH) based on the PTRS density for one panel in the set of panels, where the PTRS density for the one panel of the set of panels is based on at least one of a modulation and coding scheme (MCS) or a number of scheduled resource blocks (RBs) associated with a PDSCH reception or PUSCH transmission through the one panel.

In the aspect, the method includes receiving, from a user equipment (UE), information associated with a phase tracking reference signal (PTRS) density for each panel of a set of panels associated with the UE. The method also includes transmitting, for the UE, a configuration associated with the PTRS density for each panel of the set of panels. The method further includes communicating with the UE, based on the configuration, downlink data via a physical downlink shared channel (PDSCH) or uplink data via a physical uplink shared channel (PUSCH) based on the PTRS density for one panel in the set of panels, where the PTRS density for the one panel of the set of panels is based on at least one of a modulation and coding scheme (MCS) or a number of scheduled resource blocks (RBs) associated with a PDSCH reception or PUSCH transmission through the one panel.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating phase tracking reference signal (PTRS) density and configuration, in accordance with various aspects of the present disclosure.

FIG. 5 is a diagram illustrating UE cooperation, in accordance with various aspects of the present disclosure.

FIG. 6 is a call flow diagram for wireless communications, in accordance with various aspects of the present disclosure.

FIG. 7 is a diagram illustrating UE panels, in accordance with various aspects of the present disclosure.

FIG. 8 is a diagram illustrating of wireless communications with per-panel PTRS density for UE panels, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

Various aspects herein relate to per-panel phase tracking reference signal (PTRS) density for panels/sets of antennas of user equipment(s) (UE(s)) and configurations therefor. In NR, e.g., 5G NR, PRTS is defined for both physical downlink shared channel (PDSCH) and physical uplink shared channel (PUSCH) but is not utilized in per-panel configurations. Additionally, UE cooperation via virtual UEs with distributed panels enables improvements in radio frequency capabilities, yet the UEs in cooperation do not share a local oscillator, and thus cannot obtain phase noise correction on a per-panel basis. The described aspects provide for the ability to configure and utilize distributed panels with respective PTRS densities based on UE recommendations for PTRS thresholds for individual bands.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

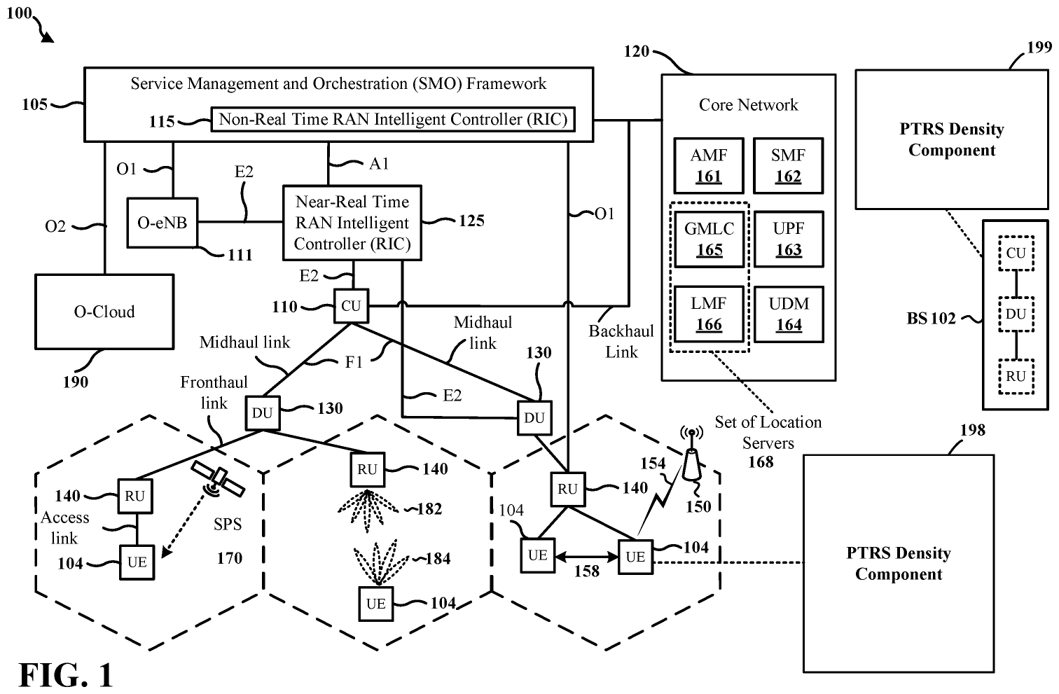

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to include a PTRS density component 198 (“component 198”) that is configured to transmit information associated with a PTRS density for each panel of a set of panels associated with the UE. The component 198 is also configured to receive, from a network entity, a configuration associated with the PTRS density for each panel of the set of panels. The component 198 is further configured to communicate, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. In some aspects, where the threshold, associated with the PTRS density that is included in the information, is a UE recommendation threshold for each panel of the set of panels, and where the configuration includes a configured threshold for each panel of the set of panels that is associated with the UE recommendation threshold, component 198 is further configured to determine the PTRS density according to the configuration based on the comparison. In some aspects, component 198 is further configured to determine at least one resource element (RE) based on the PTRS density, and to communicate, based on the configuration, the downlink data via the PDSCH or the uplink data via the PUSCH, the component 198 is configured to respectively receive or transmit PTRS information in the determined at least one RE.

In certain aspects, the base station 102 may be configured to include a PTRS density component 199 (“component 199”) that is configured to receive, from a UE, information associated with a PTRS density for each panel of a set of panels associated with the UE. The component 199 is also configured to transmit, for the UE, a configuration associated with the PTRS density for each panel of the set of panels. The component 199 is further configured to communicate with the UE, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. In some aspects, where the threshold, associated with the PTRS density that is included in the information, is a UE recommendation threshold for each panel of the set of panels, and where the configuration includes a configured threshold for each panel of the set of panels that is associated with the UE recommendation threshold, and the component 199 is further configured to configure the configured threshold for determining the PTRS density based on the UE recommendation threshold. In some aspects, the component 199 is further configured to receive an indication of at least one determined resource element (RE) that is based on the PTRS density, and to communicate, based on the configuration, the downlink data via the PDSCH or the uplink data via the PUSCH, the component 199 is configured to respectively transmit or receive PTRS information in the determined at least one RE.

Although the following description may be focused on 5G NR, the concepts described herein may be applicable to other similar areas, such as LTE, LTE-A, CDMA, GSM, and other wireless technologies.

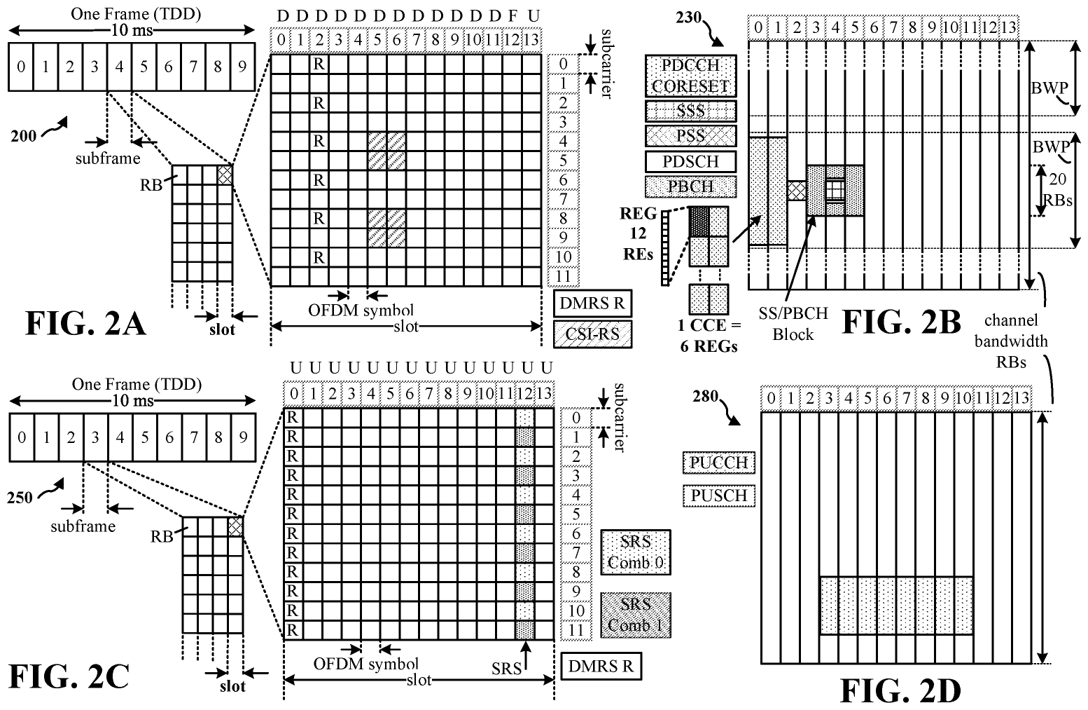

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

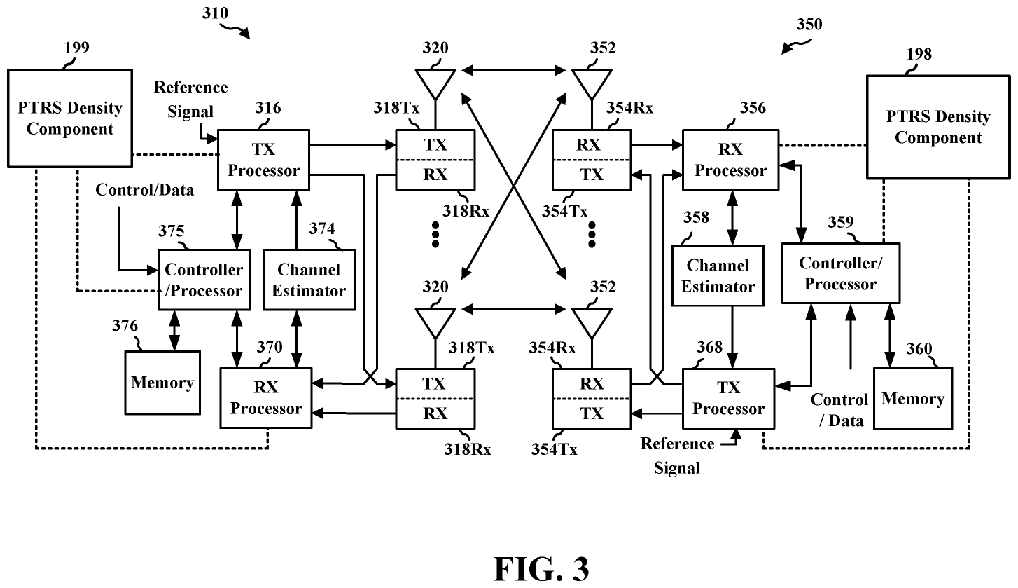

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PTRS density component 198 of FIG. 1.

At least one of the TX processor 316, the RX processor 370, and the controller/processor 375 may be configured to perform aspects in connection with the PTRS density component 199 of FIG. 1.

In NR, e.g., 5G NR, PRTS is defined for both physical downlink shared channel (PDSCH) and physical uplink shared channel (PUSCH) and may be used for phase noise correction. A given UE has its own local oscillator (LO) shared across its panels/antennas, even UEs with multiple panels have a common PTRS density without per-panel (or per TCI state/per beam) PTRS densities, not to mention cooperation via virtual UEs with distributed panels that do not share a common LO.

Aspects presented herein may provide enhancements to support PTRS density evolution for NR. Aspects presented herein may include, without limitation, PTRS density enhancements for per-panel PTRS density at UEs (e.g., separate PTRS density per panel of: individual UEs, virtual UEs, etc.), as well as PTRS density enhancements at the network side (e.g., the gNB), which improves communications through phase noise correction on individual panels, e.g., when panels/UEs are distributed. Accordingly, various aspects herein may achieve such improvements via PTRS density implementation and configuration scenarios, where a virtual UE recommends one or more (e.g., multiple) sets of thresholds per panel for a given SCS and a given frequency band. A gNB may thus configure PTRS density by configuring the thresholds for each panel individually, and a virtual UE may use the corresponding configured threshold to determine the PTRS density in time, frequency, and/or sample domains based on the specific panel used for TX/RX.

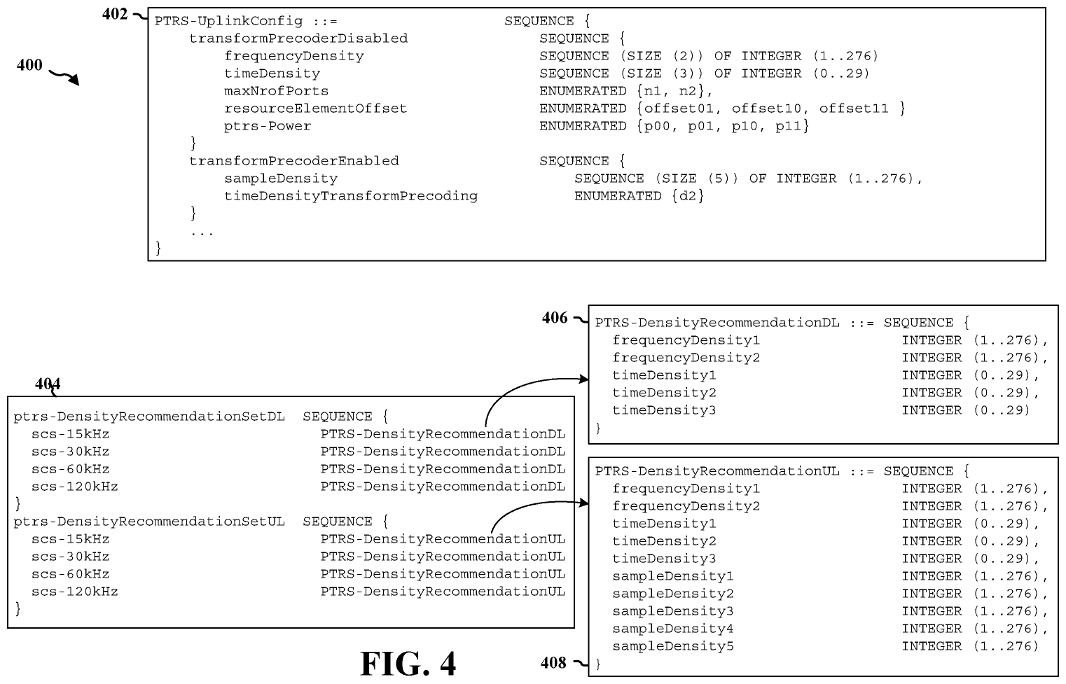

FIG. 4 is a diagram 400 illustrating PTRS density and configuration for wireless communications in a network, in various aspects. Diagram 400 includes a configuration block 402, and PTRS density sets 404. PTRS density sets 404 may correspond to a DL set 406 and an UL set 408. Diagram 400 is also described with reference to Tables 2-4 below.

Table 2 shows example values for time density of PTRS as a function of scheduled MCS, and it should be noted that the fourth threshold for time density (corresponding to the largest MCS index that does not indicate a retransmission, i.e., the largest MCS index that is not a reserved MCS) may not be explicitly configured.

TABLE 2
PTRS time density/scheduled MCS

| Scheduled MCS | Time density (L_{PTRS}) |
|---|---|
| I_{MCS} < ptrs-MCS₁ | PTRS is not present |
| ptrs-MCS₁ < I_{MCS} ≤ ptrs-MCS₂ | 4 |
| ptrs-MCS₂ < I_{MCS} ≤ ptrs-MCS₃ | 2 |
| ptrs-MCS₃ < I_{MCS} ≤ ptrs-MCS₄ | 1 |

Table 3 shows example values for frequency density of PTRS as a function of scheduled bandwidth.

TABLE 3
PTRS time density/scheduled bandwidth

| Scheduled Bandwidth | Time density (K_{PTRS}) |
|---|---|
| N_{RB} < N_{RB0} | PTRS is not present |
| N_{RB0} ≤ N_{RB} < N_{RB1} | 2 |
| N_{RB1} ≤ N_{RB} | 4 |

Table 4 shows example PTRS group patterns as a function of scheduled bandwidth.

TABLE 4
PTRS group patterns/scheduled bandwidth

| Scheduled MCS | # of PTRS groups | # of samples per PTRS group |
|---|---|---|
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

In NR, e.g., 5G NR, PRTS is defined for both physical downlink shared channel (PDSCH) and physical uplink shared channel (PUSCH). PTRS may be transmitted within allocated resource blocks (RBs) of PDSCH/PUSCH and may be used for phase noise correction. PTRS does not collide with demodulation reference signals (DMRS), non-zero power (NZP) CSI-RS, SSB, etc., and the presence of PTRS (and associated parameters) may be configured via RRC.

The density of PTRS transmission, e.g., the “PTRS density,” may be valued with respect to time and/or frequency. That is, PTRS density may be associated with a spacing between REs that PTRS is transmitted in time/frequency domains within the allocated (assigned) time/frequency (or to other data in the time/frequency domains. Density in time (e.g., every ‘L’ OFDM symbols) may depend on MCS and configurable thresholds, and density in frequency (e.g., every ‘K’ RBs) may depend on a number of scheduled RBs and configurable thresholds. When transform precoding (e.g., transformPrecoding) is enabled by the network (e.g., for PUSCH), the thresholds, with respect to the number of RBs, may determine the number of PTRS samples utilized, and as noted above, the threshold values may be configured via RRC by the network as shown for the configuration block 402 in FIG. 4.

As noted above, a UE may make a recommendation(s) on thresholds for bands, e.g., as shown for PTRS density sets 404 and the DL set 406 and the UL set 408 in FIG. 4. Based on such a recommendation(s), an RRC configuration for MCS/RB thresholds may be configured for determining PTRS density in time and/or frequency. In addition, a UE may recommend these thresholds to the network for each SCS, and the network may take in to account the UE recommendation(s) for PTRS configuration(s) (e.g., including configuring the thresholds), according to various aspects. That is, the time, frequency, and/or sample density as a function of MCS and/or the number of scheduled RBs may be dependent on the quality of the LO at a given UE. Thus, aspects may advantageously utilize the UE as being in the best position to recommend the thresholds to the network for the configurations. In aspects, the UE recommendations/reporting are/is made on a per-band basis.

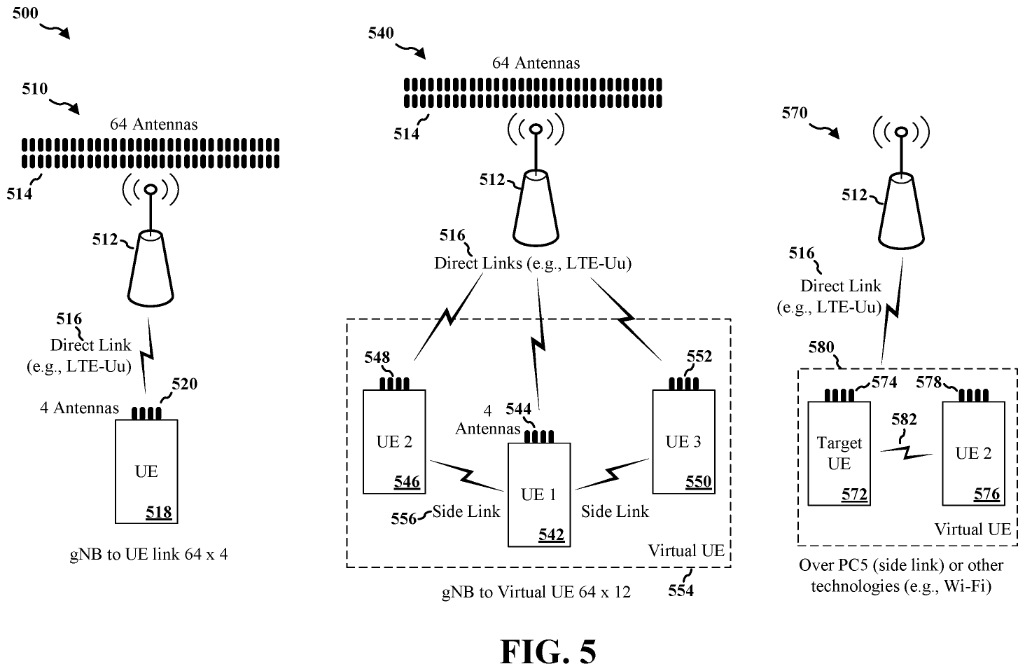

FIG. 5 is a diagram 500 illustrating UE cooperation, in various aspects. Diagram 500 includes a configuration 510, a configuration 540, and a configuration 570. Each of the configuration 510, the configuration 540, and the configuration 570 show communications between a network entity, e.g., a gNB, and one or more UEs, as described in further detail below.

For a given UE form factor, baseband modem capabilities may be higher than the RF capabilities. UE relays allow the creation of virtual UEs with a larger number of antennas, which can be exploited to increase user experience over cellular network, e.g., to create virtual MIMO effect via a larger effective number of antennas at the virtual UE. In the context of virtual UEs, a higher RF capability may provide benefits for sub 7 GHz as well as millimeter wave (mmW) implementations, where from a network-side point of view, the virtual UE is being served (e.g., as a UE with distributed panels or a distributed set of antennas).

For instance, the configuration 510 includes a gNB 512, having 64 antennas 514, by way of example, that communicates via a direct link 516 (e.g., NR-Uu) with a UE 518 that includes four (4) antennas 520, by way of example. The configuration 510 enables the direct link 516 between the gNB 512 and the UE 518 to be 64×4 (e.g., 64 antennas 514 by 4 antennas 520). In contrast, the configuration 540 includes the gNB 512, having 64 of the antennas 514 and three instances of the direct link 516 to three UEs: a UE 1 542, a UE 2 546, and a UE 3 550, which are show as respectively including four (4) antennas: 4 antennas 544, 4 antennas 548, and 4 antennas 552. In the configuration 840, the UE 1 542, the UE 2 546, and the UE 3 550 are configured as a virtual UE 554 in the illustrated configuration, and may communicate with each other over one or more of a side link 556. In such a configuration, the gNB 512 services the virtual UE 554, and thus enables the direct links 516 between the gNB 512 and the UE 1 542, the UE 2 546, and the UE 3 550 of the virtual UE 554 to be 64×12 (e.g., 64 antennas 514 by 12 antennas (4 antennas 544 plus 4 antennas 548 plus 4 antennas 552), creating a virtual MIMO effect due to the larger effective number of antennas at the virtual UE 554.

The configuration 570 also includes the gNB 512 and the direct link 516 which wirelessly connects with a virtual UE 580. The virtual UE includes a target UE 572 (having 4 antennas 574) and a UE 2 576 (having 4 antennas 578). The target UE 572 and the UE 2 576 may communicate with each other via a wireless connection 582, which may be PC5/side link, Wi-Fi, and/or the like. The described aspects for per-panel PTRS density in UE cooperation, while improving for phase noise correction, do not impact UE-to-UE communication via side link, Wi-Fi, etc., e.g., between the target UE 572 and the UE 2 576 via the wireless connection 582, even when one UE is targeted.

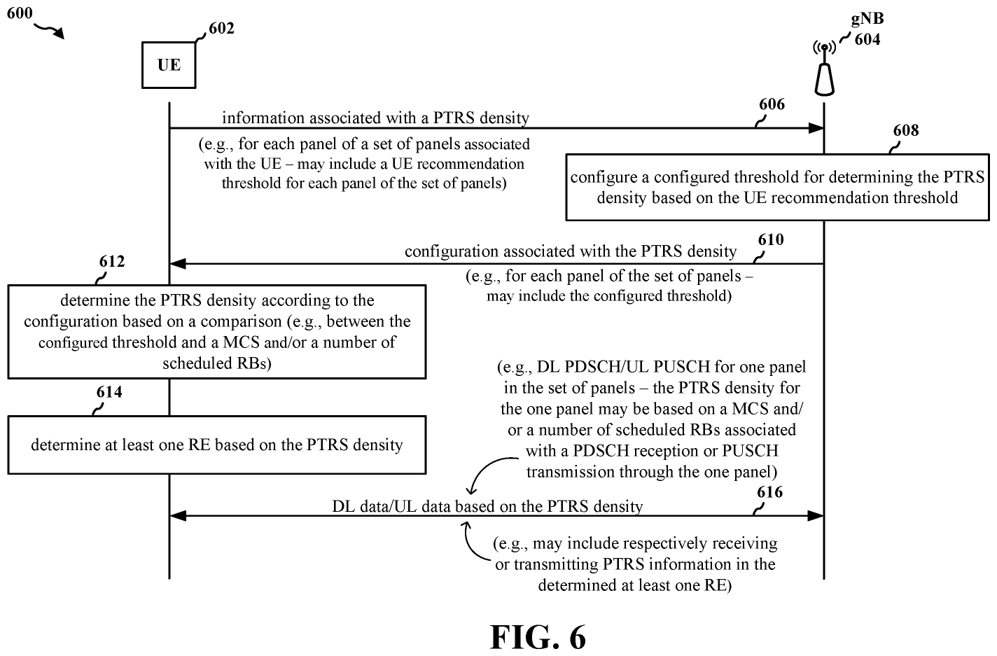

FIG. 6 is a call flow diagram 600 for wireless communications, in various aspects. Call flow diagram 600 illustrates configuring and utilizing per-panel PTRS density in UE cooperation.

In the illustrated aspect, a UE 602 transmits, to a network node (e.g., a gNB 604 or one or more components of a gNB, a BS, and/or the like), information 606 associated with a PTRS density for each panel of a set of panels associated with the UE 602. The information 606 transmitted to the gNB 604 from the UE 602, in one configuration, may include, without limitation, a recommendation threshold of the UE 602 for each panel of the set of panels. The gNB 604 generates a configuration for PTRS thresholds including configuring at 608 a configured threshold for determining the PTRS density based on the UE 602 recommendation threshold in the information 606. The gNB 604 transmits, and the UE 602 receives, a configuration 610 that is associated with the PTRS density for each panel of the set of panels. In one configuration, the set of panels may be associated with a set of UEs, and in one configuration, the UE 602 may include the set of UEs that may include a set of relay UEs, where a relay UE is a UE that communicates with other UEs to extend/enhance network coverage or to enhance the RF capabilities of the virtual UE. In one configuration, the UE 602 may be a virtual UE.

In one configuration, the set of panels may include a plurality of panels, where each panel may be associated with a different UE in the set of UEs (e.g., in the virtual UE). In aspects, the configuration 610 may include the configured threshold that is configured at 608. In one configuration, each panel in the set of panels may respectively be specified by at least one of an explicit panel identifier (ID), a beam group ID, a transmission configuration indicator (TCI) state group ID, an association with a control resource set (CORESET) group, an association with a sounding reference signal (SRS) resource set, one or more port numbers associated with the communication, a code division multiplexed (CDM) group of one or more demodulation reference signal (DMRS) port numbers, an association with a time advance group (TAG) ID, or a radio network temporary ID (RNTI).

The UE 602 determines at 612 the PTRS density according to the configuration 610. In aspects, the UE 602 determines the PTRS density based on a comparison between the configured threshold of the configuration 610 and a modulation and coding scheme (MCS) and/or a number of scheduled RBs, e.g., as described in Tables 2-4 above. The UE 602 determines at 614 at least one resource element (RE) based on the PTRS density at 612. In one configuration, the RE(s) are determined based on a scheduling for time/frequency of a PDSCH and/or a PUSCH.

DL data and/or UL data 616 are communicated between the UE 602 and the gNB 604 based on the PTRS density determined at 612. In one configuration, the DL data and/or UL data 616 are communicated respectively via a DL PDSCH and a UL PUSCH for one panel in the set of panels. In one configuration, the PTRS density for the one panel may be based on the MCS and/or the number of scheduled RBs (at 612) associated with a PDSCH reception or PUSCH transmission through the one panel. In one configuration, communicating the DL data and/or UL data 616 may include respectively receiving or transmitting PTRS information in the determined at least one RE (at 614). In one configuration, the PDSCH or the PUSCH communicated via the one panel may include at least a portion of the PDSCH or the PUSCH, respectively.

In one configuration, the communicated DL data (e.g., 616) may include the DL data via the PDSCH received on the one panel and other downlink data via another PDSCH received on another panel of the set of panels. In one configuration, the PDSCH and the other PDSCH are fully-overlapping, partially-overlapping, or non-overlapping with respect to each other in at least one of time or frequency. In one configuration, the PTRS density for the PDSCH received on the one panel and another PTRS density for the other PDSCH received on the other panel may be independent of each other. In one configuration, the communicated DL data (e.g., 616) may be based on a multiple downlink control information (multi-DCI) based multiple transmission and reception point (mTRP) PDSCH transmission framework, and the PDSCH and the other PDSCH are each associated with a corresponding control resource set (CORESET) pool index that respectively represent the one panel and the other panel as associated with the PDSCH/PUSCH.

In one configuration, the communicated DL data (e.g., 616) may include the DL data via the PDSCH, where the PDSCH may include a first portion received on the one panel and may include a second portion received on another panel of the set of panels. In the configuration, the PTRS density for the first portion received on the one panel and another PTRS density for the second portion received on the other panel may be independent of each other, and the first portion and the second portion may respectively include at least one transmission. In the configuration, the at least one transmission may include a first set of layers and a second set of layers of the PDSCH for spatial division multiplexing (SDM), where the PTRS density of the first set of layers and the other PTRS density of the second set of layers are associated respectively with two sets of PTRS ports that may be independent of each other with respect to at least one of a time domain or a frequency domain. In the configuration, the at least one transmission may include a first set of RBs and a second set of RBs of the PDSCH for frequency division multiplexing (FDM), where the PTRS density of the first set of RBs and the other PTRS density of the second set of RBs may be independent of each other with respect to at least one of a time domain or a frequency domain. In the configuration, the at least one transmission may include a first set of symbols and a second set of symbols of the PDSCH for time division multiplexing (TDM), where the PTRS density of the first set of symbols and the other PTRS density of the second set of symbols may be independent of each other with respect to at least one of a time domain or a frequency domain. In the configuration, the at least one transmission may include a same set of layers, RBs, or symbols of the PDSCH for a system frame number (SFN) implementation, where the PTRS density of the same set of layers, RBs, or symbols and the other PTRS density of the same set of layers, RBs, or symbols may be independent of each other with respect to at least one of a time domain or a frequency domain. A resource block may be the smallest unit of resource allocation in wireless communications described herein, where a resource element is the smallest unit of a resource block, as similarly noted above regarding resource grids and frame structure.

In one configuration, the communicated UL data (e.g., 616) may include the uplink data via the PUSCH transmitted on the one panel and other uplink data via another PUSCH transmitted on another panel of the set of panels, where the PUSCH and the other PUSCH are fully-overlapping, partially-overlapping, or non-overlapping with respect to each other in at least one of time or frequency. In one configuration, the PTRS density for the PUSCH transmitted on the one panel and another PTRS density for the other PUSCH transmitted on the other panel may be independent of each other. In one configuration, the communicating of the UL data (e.g., 616) may be based on a multiple downlink control information (multi-DCI) based multiple transmission and reception point (mTRP) PUSCH transmission framework, where the PUSCH and the other PUSCH may each be associated with a corresponding control resource set (CORESET) pool index (e.g., coresetPoolIndex) or sounding reference signal (SRS) resource set that respectively represent the one panel and the other panel.

In one configuration, the communicated UL data (e.g., 616) may include the uplink data via the PUSCH, where the PUSCH may include a first portion transmitted on the one panel and may include a second portion transmitted on another panel of the set of panels, where the PTRS density for the first portion transmitted on the one panel and another PTRS density for the second portion transmitted on the other panel are independent of each other, and where the first portion and the second portion may respectively include at least one transmission. In the configuration, the at least one transmission may include a first set of layers and a second set of layers of the PUSCH for SDM, where the PTRS density of the first set of layers and the other PTRS density of the second set of layers are associated respectively with two sets of PTRS ports that are independent of each other with respect to at least one of a time domain, a frequency domain, or a sample domain. In the configuration, the at least one transmission may include a first set of RBs and a second set of RBs of the PUSCH for FDM, where the PTRS density of the first set of RBs and the other PTRS density of the second set of RBs are independent of each other with respect to at least one of a time domain or a frequency domain. In the configuration, the at least one transmission may include a first set of symbols and a second set of symbols of the PUSCH for TDM, where the PTRS density of the first set of symbols and the other PTRS density of the second set of symbols are independent of each other with respect to at least one of a time domain or a frequency domain. In the configuration, the at least one transmission may include a same set of layers, RBs, or symbols of the PUSCH for a SFN implementation, where the PTRS density of the same set of layers, RBs, or symbols and the other PTRS density of the same set of layers, RBs, or symbols are independent of each other with respect to at least one of a time domain or a frequency domain.

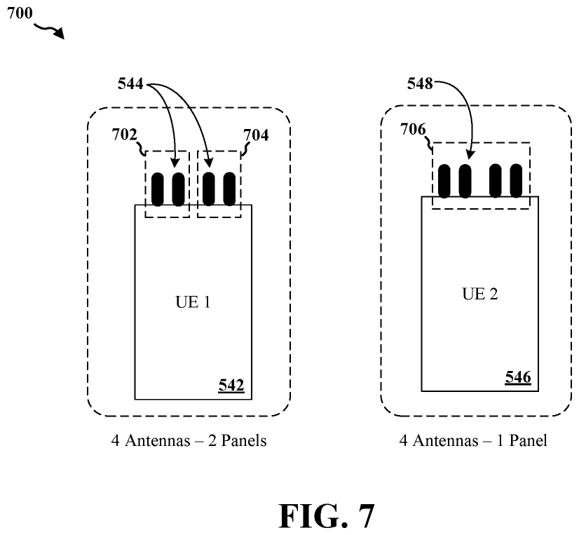

FIG. 7 is a diagram 700 illustrating UE panels, in various aspects. Diagram 700 includes the UE 1 542 and the UE 2 546, described above with respect to FIG. 5. As an example, in the context of UE cooperation, virtual UEs, and/or distributed panels/sets of antennas, a panel may be a set of antennas of one or more UEs, e.g., one or more UEs and relay UEs that are included in a virtual UE, where each panel is configured for transmission/reception of wireless signals separate from other panels. In aspects, a UE and/or virtual UE may include more than one panel, and panels may be distributed amongst different UEs included in a virtual UE. Put another way, a panel of a UE may generally represent a set of antennas that can form a beam independent from other sets of antennas corresponding to other panels. The UE 1 542 includes the 4 antennas 544, and the UE 2 546 includes the 4 antennas 548. The 4 antennas 544 are illustrated in diagram 700 as being configured in two panels: a panel 702 having a first two of the 4 antennas 544, and a panel 704 having a second two of the 4 antennas 544. The 4 antennas 548 are illustrated in diagram 700 as being configured as a single panel 706. The panel configurations illustrated in diagram 700 are by way of example, and are not limiting, as it is contemplated herein that UEs may have more than, or fewer than, 4 antennas and that a panel may include any number of antennas.

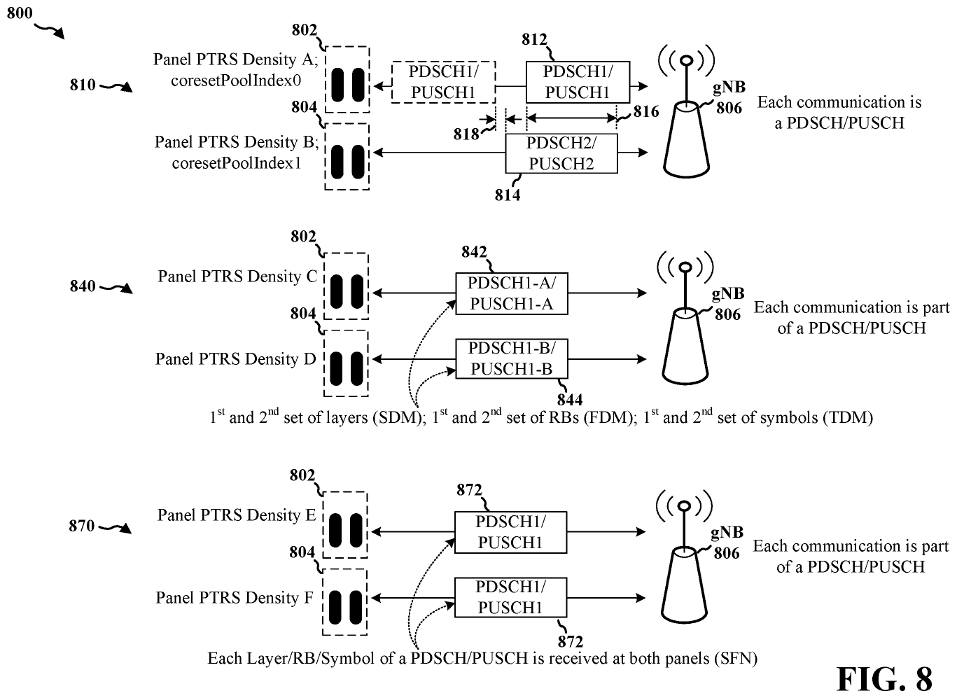

FIG. 8 is a diagram illustrating of wireless communications with per-panel PTRS density for UE panels, in various aspects. FIG. 8 shows three configurations for wireless communication with per-panel PTRS density for UE panels: a configuration 810, a configuration 840, and a configuration 870, where each configuration is illustrated with reference to a panel 802 (of two antennas), a panel 804 (of two antennas), a gNB 806, by way of example and not limitation. The panel 802 and the panel 804, in the illustrated configurations, are distributed panels of UEs included in a virtual UE (not shown for illustrative clarity and brevity; referenced at 548 of FIG. 5) and may be aspects of the panels described above with respect to diagram 700 of FIG. 7.

Configuration 810 shows a configuration where each communication is a PDSCH/PUSCH. For instance, a first PDSCH1/PUSCH1 812 may be communicated between the gNB 806 and the panel 802, while a second PDSCH2/PUSCH2 814, e.g., a different PDSCH/PUSCH, may be communicated between the gNB 806 and the panel 804. In one configuration, the first PDSCH1/PUSCH1 812 and the second PDSCH2/PUSCH2 814 may be overlapping in whole or in part (816), or may be non-overlapping (818). In configuration 810, the panel 802 may have a panel PTRS density A and a CORESET pool index (e.g., coresetPoolIndex0), while the panel 804 may have a panel PTRS density B, which may be the same or different from panel PTRS density A, and another CORESET pool index (e.g., coresetPoolIndex1). It should be noted that while the panel PTRS density A and the panel PTRS density B may be the same or different, each panel density is specifically determined for its respective panel and PDSCH/PUSCH, e.g., may be independent of each other, as noted for various aspects herein, and not for a number of RBs, different MCSs, etc. In one configuration, communicated DL data for a PDSCH1 portion of 812 may be based on a multiple downlink control information (multi-DCI) based multiple transmission and reception point (mTRP) PDSCH transmission framework.

Configuration 840 shows a configuration where each communication is a part of a PDSCH/PUSCH. For instance, a first PDSCH1-A/PUSCH1-A part 842 may be communicated between the gNB 806 and the panel 802, while a second PDSCH1-B/PUSCH1-B part 844 may be communicated between the gNB 806 and the panel 804. In configuration 840, the panel 802 may have a panel PTRS density C, while the panel 804 may have a panel PTRS density D, which may be the same or different from panel PTRS density C. In one configuration, the first PDSCH1-A/PUSCH1-A part 842 and the second PDSCH1-B/PUSCH1-B part 844 may respectively be a first set of layers and a second set of layers of a PDSCH/PUSCH for SDM, where the panel PTRS density C and the panel PTRS density D are associated respectively with two sets of PTRS ports that may be independent of each other with respect to at least one of a time domain or a frequency domain. In one configuration, the first PDSCH1-A/PUSCH1-A part 842 and the second PDSCH1-B/PUSCH1-B part 844 may respectively be a first set of RBs and a second set of RBs of a PDSCH/PUSCH for FDM, where the panel PTRS density C and the panel PTRS density D may be independent of each other with respect to at least one of a time domain or a frequency domain. In one configuration, the first PDSCH1-A/PUSCH1-A part 842 and the second PDSCH1-B/PUSCH1-B part 844 may respectively be a first set of symbols and a second set of symbols of the PDSCH for TDM, where the PTRS density of the first set of symbols and the other PTRS density of the second set of symbols may be independent of each other with respect to at least one of a time domain or a frequency domain.

Configuration 870 shows a configuration where each communication is a part of a PDSCH/PUSCH. For instance, a PDSCH1/PUSCH1 part 872 may be communicated between the gNB 806 and the panel 802, while the PDSCH1/PUSCH1 part 872 may also be communicated between the gNB 806 and the panel 804. In configuration 870, the panel 802 may have a panel PTRS density E, while the panel 804 may have a panel PTRS density F, which may be the same or different from panel PTRS density E. In one configuration, the PDSCH1/PUSCH1 part 872 may respectively be a same set of layers, RBs, or symbols of a PDSCH/PUSCH for a SFN implementation, where the panel PTRS density E and the panel PTRS density F may be independent of each other with respect to at least one of a time domain or a frequency domain.

It should be noted that in all cases illustrated for diagram 800 in FIG. 8, the PDSCH/PUSCH may have two (or multiple) different PTRS densities for panels (e.g., distributed panels: the panel 802 and the panel 804) based on corresponding configured thresholds, as described herein. Additionally, for UL (e.g., PUSCH) scenarios/configurations described and depicted, SRS may represent and/or determine association with a panel.

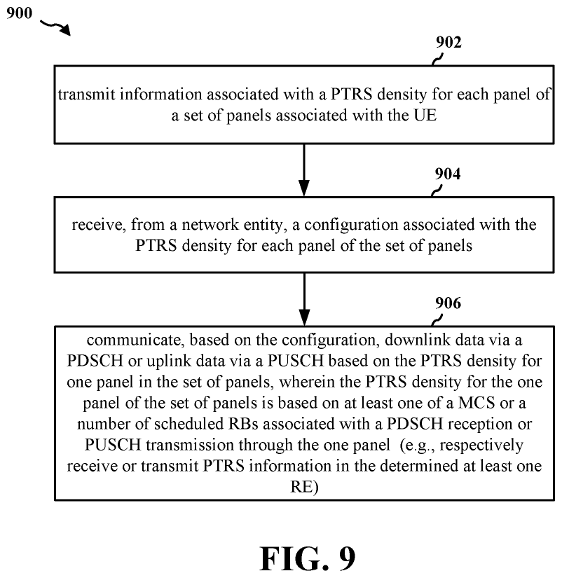

FIG. 9 is a flowchart 900 of a method of wireless communication, in accordance with various aspects of the present disclosure. The method may be performed by a UE (e.g., the UE 104, 602; the apparatus 1304). At 902, the UE transmits information associated with a PTRS density for each panel of a set of panels associated with the UE. In some aspects, 902 may be performed by the component 198. Additionally, at 904, the UE receives, from a network entity, a configuration associated with the PTRS density for each panel of the set of panels. In some aspects, 904 may be performed by the component 198. Finally, at 906, the UE communicates, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. In some aspects, 906 may be performed by the component 198. For example, referring to FIG. 6, the UE 602 may transmit information 606 associated with a PTRS density for each panel of a set of panels associated with the UE. The information 606 associated with a PTRS density for each panel may be transmitted to the gNB 604 and may include a UE recommendation threshold for the PTRS density for each panel (e.g., as described above in Tables 2-4). In aspects, the UE may be a virtual UE that includes a set of UEs with distributed panels (e.g., sets of antennas for each UE in the set) (554 of FIG. 5; 802, 804 as representative in FIG. 8). In addition, the configuration 610 in FIG. 6 may include a threshold configured by gNB 604 for PTRS density based on the UE recommendation threshold in information 606. The DL data and/or UL data 616 that are communicated between the UE 602 and the gNB 604, based on the PTRS density determined, may be communicated via PDSCH/PUSCH and may include separate PDSCHs/PUSCHs (e.g., 812/814 of FIG. 8) or parts of a PDSCH/PUSCH (842/844, 872 of FIG. 8), in aspects.

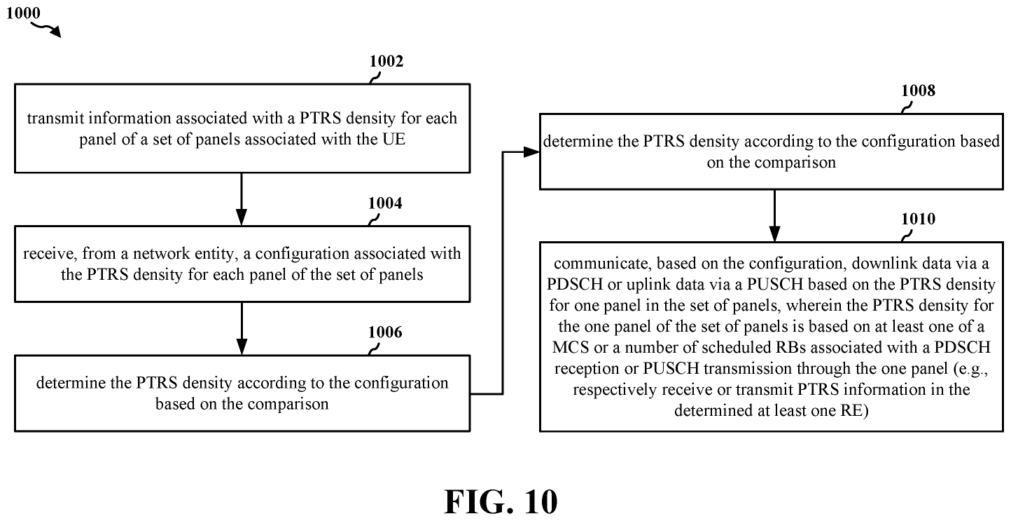

FIG. 10 is a flowchart 1000 of a method of wireless communication, in accordance with various aspects of the present disclosure. The method may be performed by a UE (e.g., the UE 104, 602; the apparatus 1304). At 1002, the UE transmits information associated with a PTRS density for each panel of a set of panels associated with the UE. In some aspects, 1002 may be performed by the component 198. At 1004, the UE receives, from a network entity, a configuration associated with the PTRS density for each panel of the set of panels. In some aspects, 1004 may be performed by the component 198. Additionally, at 1006 the UE determines the PTRS density according to the configuration based on the comparison. In some aspects, 1006 may be performed by the component 198. Further, at 1008, the UE determines the PTRS density according to the configuration based on the comparison. In some aspects, 1008 may be performed by the component 198. Finally, at 1010, the UE communicates, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. In some aspects, 1010 may be performed by the component 198.

For example, referring again to FIG. 6, the UE 602 may transmit information 606 associated with a PTRS density for each panel of a set of panels associated with the UE. The information 606 associated with a PTRS density for each panel may be transmitted to the gNB 604 and may include a UE recommendation threshold for the PTRS density for each panel (e.g., as described above in Tables 2-4). In aspects, the UE may be a virtual UE that includes a set of UEs with distributed panels (e.g., sets of antennas for each UE in the set) (554 of FIG. 5; 802, 804 as representative in FIG. 8). In addition, the configuration 610 in FIG. 6 may include a threshold configured by the gNB 604 for PTRS density based on the UE recommendation threshold in information 606. Utilizing the configuration 610 associated with the PTRS density for each panel, the UE may determine at 612 the PTRS density per panel/band (e.g., as described above in Tables 2-4) based on a comparison between the configured threshold in the configuration 610 and a MCS and/or a number of scheduled RBs. The UE may then determine at 614 at least one RE based on the PTRS density for transmission/reception of wireless communications. The DL data and/or UL data 616 that are communicated between the UE 602 and the gNB 604, based on the PTRS density determined, may be communicated via PDSCH/PUSCH and may include separate PDSCHs/PUSCHs (e.g., 812/814 of FIG. 8) or parts of a PDSCH/PUSCH (842/844, 872 of FIG. 8), in aspects. In aspects, the communication of DL data and/or UL data 616 may include PTRS information that is received/transmitted in the determined RE at 614.

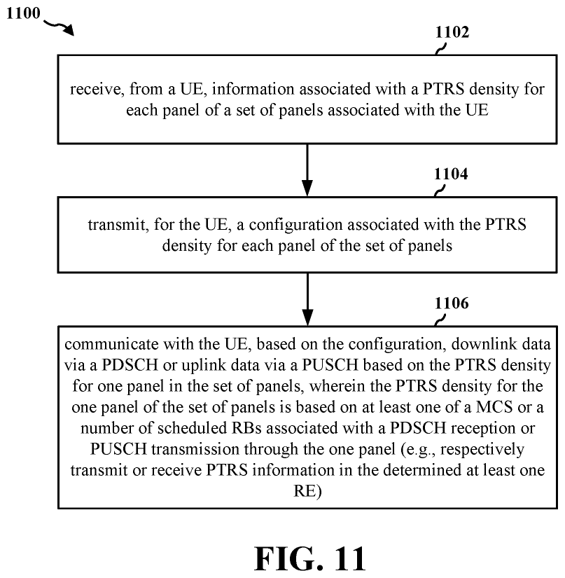

FIG. 11 is a flowchart 1100 of a method of wireless communication, in accordance with various aspects of the present disclosure. The method may be performed by a network entity, a base station, or a gNB (e.g., the base station 102; gNB 604, gNB 806; the network entity 1302, 1402). At 1102, the network entity receives, from a UE, information associated with a PTRS density for each panel of a set of panels associated with the UE. For example, as described in relation to FIG. 6, the gNB 604 may receive information 606 associated with a PTRS density for each panel of a set of panels associated with the UE. The information 606 associated with a PTRS density for each panel may be received by the gNB 604 from the UE 602 and may include a UE recommendation threshold for the PTRS density for each panel (e.g., as described above in Tables 2-4). In aspects, the UE may be a virtual UE that includes a set of UEs with distributed panels (e.g., sets of antennas for each UE in the set) (554 of FIG. 5; 802, 804 as representative in FIG. 8). In some aspects, 1102 may be performed by the component 199. Additionally, at 1104, the network entity transmits, for the UE, a configuration associated with the PTRS density for each panel of the set of panels. For example, referring to FIG. 6, the configuration 610 in FIG. 6 may include a threshold configured by the gNB 604 for PTRS density based on the UE 602 recommendation threshold in the information 606. In some aspects, 1104 may be performed by the component 199. Finally, at 1106, the network entity communicates with the UE, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. For example, referring to FIG. 6, the DL data and/or UL data 616 that are communicated between the UE 602 and the gNB 604, based on the PTRS density determined utilizing the configuration 610, may be communicated via PDSCH/PUSCH and may include separate PDSCHs/PUSCHs (e.g., 812/814 of FIG. 8) or parts of a PDSCH/PUSCH (842/844, 872 of FIG. 8), in aspects. In some aspects, 1106 may be performed by the component 199.

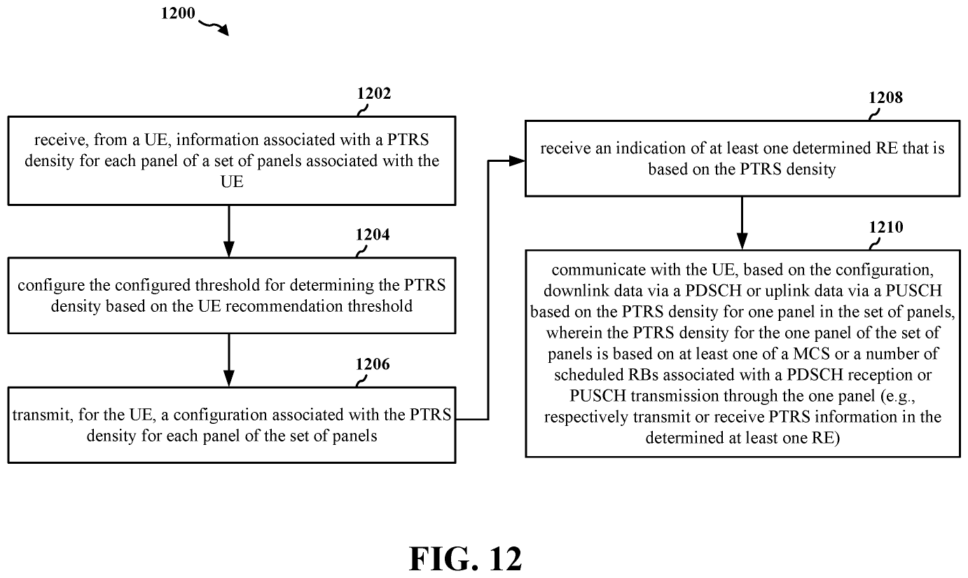

FIG. 12 is a flowchart 1200 of a method of wireless communication, in accordance with various aspects of the present disclosure. The method may be performed by a network entity, a base station, or a gNB (e.g., the base station 102; gNB 604, gNB 806; the network entity 1302, 1402). At 1202, the network entity receives, from a UE, information associated with a PTRS density for each panel of a set of panels associated with the UE. For example, referring again to FIG. 6, the gNB 604 may receive information 606 associated with a PTRS density for each panel of a set of panels associated with the UE. The information 606 associated with a PTRS density for each panel may be received by the gNB 604 from the UE 602 and may include a UE recommendation threshold for the PTRS density for each panel (e.g., as described above in Tables 2-4). In aspects, the UE may be a virtual UE that includes a set of UEs with distributed panels (e.g., sets of antennas for each UE in the set) (554 of FIG. 5; 802, 804 as representative in FIG. 8). In some aspects, 1202 may be performed by the component 199. At 1204, the network entity may configure the configured threshold for determining the PTRS density based on the UE recommendation threshold. For example, referring to FIG. 6, the gNB 604 may configure at 608 a (configured) threshold for determining the PTRS density based on the UE recommendation threshold in information 606. In some aspects, 1204 may be performed by the component 199.

Additionally, at 1206, the network entity transmits, for the UE, a configuration associated with the PTRS density for each panel of the set of panels. For example, referring to FIG. 6, the configuration 610 may be transmitted to the UE 602 and may include the configured threshold that is configured at 608 by the gNB 604 for PTRS density based on the UE recommendation threshold. In some aspects, 1206 may be performed by the component 199. Further, at 1208, the network entity may receive an indication of at least one determined RE that is based on the PTRS density. For example, referring to FIG. 6, and as noted above, the UE 602 may determine at 614 one or more REs based on the PTRS density in which to receive/transmit PTRS information, and the gNB 604 may receive an indication of the one or more Res from the UE 602. In some aspects, 1208 may be performed by the component 199. Finally, at 1210, the network entity communicates with the UE, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. For example, referring to FIG. 6, the DL data and/or UL data 616 that are communicated between the UE 602 and the gNB 604, based on the PTRS density determined utilizing the configuration 610, may be communicated via PDSCH/PUSCH and may include separate PDSCHs/PUSCHs (e.g., 812/814 of FIG. 8) or parts of a PDSCH/PUSCH (842/844, 872 of FIG. 8), in aspects. In some aspects, 1210 may be performed by the component 199.

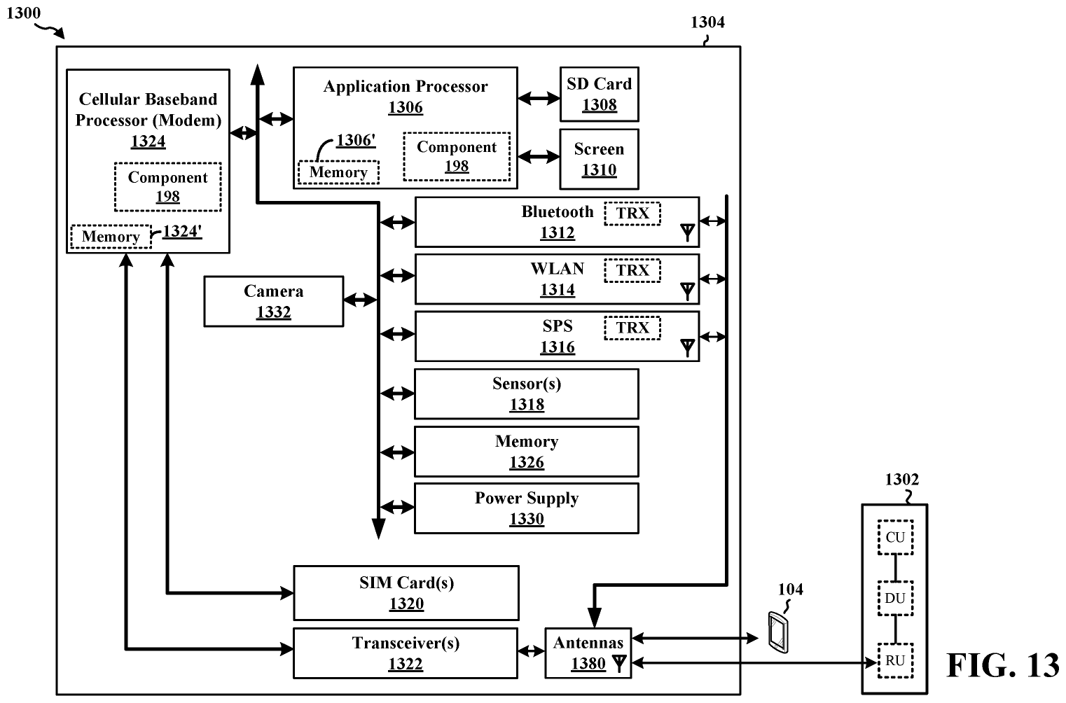

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 is configured to transmit information associated with a PTRS density for each panel of a set of panels associated with the UE. Additionally, the component 198 is configured to receive, from a network entity, a configuration associated with the PTRS density for each panel of the set of panels. Additionally, the component 198 is configured to communicate, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. In aspects, the component 198 may be configured to determine the PTRS density according to the configuration based on the comparison. In some aspects, the component 198 may be configured to determine the PTRS density according to the configuration based on the comparison. The component 198 may be further configured to perform any of the aspects described in connection with FIGS. 9, 10, 11, 12, and/or performed by the UE 602 in FIG. 6. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for transmitting information associated with a PTRS density for each panel of a set of panels associated with the UE. In one configuration, the apparatus 1304, and in particular the cellular baseband processor 1324 and/or the application processor 1306, includes means for receiving, from a network entity, a configuration associated with the PTRS density for each panel of the set of panels. In one configuration, the apparatus 1304, and in particular the cellular baseband processor 1324 and/or the application processor 1306. The apparatus 1304, and in particular the cellular baseband processor 1324 and/or the application processor 1306, may include means for performing any of the aspects described in connection with FIGS. 9, 10, 11, 12, and/or performed by the UE 602 in FIG. 6. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

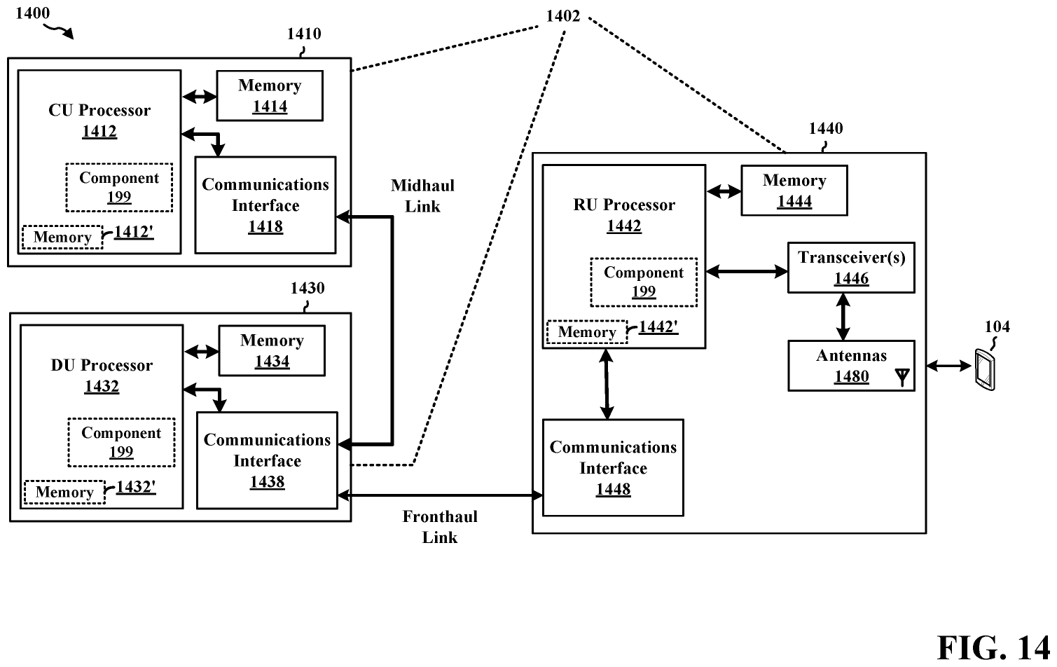

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive, from a UE, information associated with a PTRS density for each panel of a set of panels associated with the UE. Additionally, the component 199 is configured to transmit, for the UE, a configuration associated with the PTRS density for each panel of the set of panels. Additionally, the component 199 is configured to communicate with the UE, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. Additionally, the component 199 may be configured to configure the configured threshold for determining the PTRS density based on the UE recommendation threshold, and may be configured to receive an indication of at least one determined RE that is based on the PTRS density. The component 199 may be further configured to perform any of the aspects described in connection with FIGS. 9, 10, 11, 12, and/or performed by the gNB 604 in FIG. 6. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for receiving, from a UE, information associated with a PTRS density for each panel of a set of panels associated with the UE. In one configuration, the network entity 1402 includes means for transmitting, for the UE, a configuration associated with the PTRS density for each panel of the set of panels. In one configuration, the network entity 1402 includes means for communicating with the UE, based on the configuration, downlink data via a PDSCH or uplink data via a PUSCH based on the PTRS density for one panel in the set of panels, where the PTRS density for the one panel of the set of panels is based on at least one of a MCS or a number of scheduled RBs associated with a PDSCH reception or PUSCH transmission through the one panel. Additionally, in one configuration, the network entity 1402 may include means for configuring the configured threshold for determining the PTRS density based on the UE recommendation threshold, and for receiving an indication of at least one determined RE that is based on the PTRS density. The network entity 1402 may include means for performing any of the aspects described in connection with FIGS. 9, 10, 11, 12, and/or performed by the gNB 604 in FIG. 6. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

Some aspects of wireless communications, e.g., NR, 5G NR, etc., PRTS is defined for both physical downlink shared channel (PDSCH) and physical uplink shared channel (PUSCH) but is not utilized in per-panel configurations. Additionally, UE cooperation via virtual UEs with distributed panels enables improvements in radio frequency capabilities, yet the UEs in cooperation do not share a local oscillator, and thus cannot obtain phase noise correction on a per-panel basis. The described aspects for per-panel PTRS density for panels/sets of antennas of UEs, including virtual UEs, provide for the ability to configure and utilize distributed panels with respective PTRS densities based on UE recommendations for PTRS thresholds for individual bands. The aspects presented herein may provide enhancements to support PTRS density evolution for NR, and may include, without limitation, PTRS density enhancements for per-panel PTRS density at UEs (e.g., separate PTRS density per panel of: individual UEs, virtual UEs, etc.), as well as PTRS density enhancements at the network side (e.g., a gNB), which improves communications through phase noise correction on individual panels, e.g., when panels/UEs are distributed. Accordingly, various aspects herein may achieve such improvements via PTRS density implementation and configuration scenarios, where a virtual UE recommends one or more (e.g., multiple) sets of thresholds per panel for a given SCS and a given frequency band. A gNB may thus configure PTRS density by configuring the thresholds for each panel individually, and a virtual UE may use the corresponding configured threshold to determine the PTRS density in time, frequency, and/or sample domains based on the specific panel used for TX/RX.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE) or a wireless device, including a memory and at least one processor coupled to the memory and, based at least in part on information stored in the memory, the at least one processor is configured to: transmit information associated with a phase tracking reference signal (PTRS) density for each panel of a set of panels associated with the UE; receive, from a network entity, a configuration associated with the PTRS density for each panel of the set of panels; and communicate, based on the configuration, downlink data via a physical downlink shared channel (PDSCH) or uplink data via a physical uplink shared channel (PUSCH) based on the PTRS density for one panel in the set of panels, where the PTRS density for the one panel of the set of panels is based on at least one of a modulation and coding scheme (MCS) or a number of scheduled resource blocks (RBs) associated with a PDSCH reception or PUSCH transmission through the one panel.

Aspect 2 is the apparatus of aspect 1, where the set of panels is associated with a set of UEs, where the UE includes the set of UEs including a set of relay UEs.

Aspect 3 is the apparatus of any of aspects 1 and 2, where the set of panels includes a plurality of panels, and where each panel is associated with a different UE in the set of UEs.

Aspect 4 is the apparatus of any of aspects 1 to 3, where the information includes a threshold associated with the PTRS density, and where the PTRS density is based on a comparison between the threshold and the MCS or a number of scheduled RBs.

Aspect 5 is the apparatus of aspect 4, where the threshold, associated with the PTRS density that is included in the information, is a UE recommendation threshold for each panel of the set of panels, and where the configuration includes a configured threshold for each panel of the set of panels that is associated with the UE recommendation threshold, and the at least one processor is further configured to: determine the PTRS density according to the configuration based on the comparison.

Aspect 6 is the apparatus of any of aspects 1 to 5, where the PDSCH or the PUSCH communicated via the one panel includes at least a portion of the PDSCH or the PUSCH, respectively.

Aspect 7 is the apparatus of any of aspects 1 to 6, where the at least one processor is further configured to: determine at least one resource element (RE) based on the PTRS density; where the apparatus further includes at least one transceiver coupled to the at least one processor, and where to communicate, based on the configuration, the downlink data via the PDSCH or the uplink data via the PUSCH, the at least one processor is configured to: respectively receive or transmit PTRS information in the determined at least one RE via the at least one transceiver.

Aspect 8 is the apparatus of any of aspects 1 to 7, where each panel in the set of panels is respectively specified by at least one of an explicit panel identifier (ID), a beam group ID, a transmission configuration indicator (TCI) state group ID, an association with a control resource set (CORESET) group, an association with a sounding reference signal (SRS) resource set, one or more port numbers associated with the communication, a code division multiplexed (CDM) group of one or more demodulation reference signal (DMRS) port numbers, an association with a time advance group (TAG) ID, or a radio network temporary ID (RNTI).

Aspect 9 is the apparatus of any of aspects 1 to 8, where the communicated downlink data includes the downlink data via the PDSCH received on the one panel and other downlink data via another PDSCH received on another panel of the set of panels, where the PDSCH and the another PDSCH are fully-overlapping, partially-overlapping, or non-overlapping with respect to each other in at least one of time or frequency, and where the PTRS density for the PDSCH received on the one panel and another PTRS density for the another PDSCH received on the another panel are independent of each other.

Aspect 10 is the apparatus of aspect 9, where the communicated downlink data is based on a multiple downlink control information (multi-DCI) based multiple transmission and reception point (mTRP) PDSCH transmission framework, and where the PDSCH and the another PDSCH are each associated with a corresponding control resource set (CORESET) pool index that respectively represents the one panel and the another panel.

Aspect 11 is the apparatus of any of aspects 1 to 10, where the communicated downlink data includes the downlink data via the PDSCH, where the PDSCH includes a first portion received on the one panel and includes a second portion received on another panel of the set of panels, where the PTRS density for the first portion received on the one panel and another PTRS density for the second portion received on the another panel are independent of each other, and where the first portion and the second portion respectively include at least one of: a first set of layers and a second set of layers of the PDSCH for spatial division multiplexing (SDM), where the PTRS density of the first set of layers and the another PTRS density of the second set of layers are associated respectively with two sets of PTRS ports that are independent of each other with respect to at least one of a time domain or a frequency domain; a first set of RBs and a second set of RBs of the PDSCH for frequency division multiplexing (FDM), where the PTRS density of the first set of RBs and the another PTRS density of the second set of RBs are independent of each other with respect to at least one of a time domain or a frequency domain; a first set of symbols and a second set of symbols of the PDSCH for time division multiplexing (TDM), where the PTRS density of the first set of symbols and the another PTRS density of the second set of symbols are independent of each other with respect to at least one of a time domain or a frequency domain; or a same set of layers, RBs, or symbols of the PDSCH for a system frame number (SFN) implementation, where the PTRS density of the same set of layers, RBs, or symbols and the another PTRS density of the same set of layers, RBs, or symbols are independent of each other with respect to at least one of a time domain or a frequency domain.

Aspect 12 is the apparatus of any of aspects 1 to 8, where the communicated uplink data includes the uplink data via the PUSCH transmitted on the one panel and other uplink data via another PUSCH transmitted on another panel of the set of panels, where the PUSCH and the another PUSCH are fully-overlapping, partially-overlapping, or non-overlapping with respect to each other in at least one of time or frequency, and where the PTRS density for the PUSCH transmitted on the one panel and another PTRS density for the another PUSCH transmitted on the another panel are independent of each other.

Aspect 13 is the apparatus of aspect 12, where the communicating is based on a multiple downlink control information (multi-DCI) based multiple transmission and reception point (mTRP) PUSCH transmission framework, and where the PUSCH and the another PUSCH are each associated with a corresponding control resource set (CORESET) pool index or sounding reference signal (SRS) resource set that respectively represent the one panel and the another panel.

Aspect 14 is the apparatus of any of aspects 1 to 8 and 12 to 13, where the communicated uplink data includes the uplink data via the PUSCH, where the PUSCH includes a first portion transmitted on the one panel and includes a second portion transmitted on another panel of the set of panels, where the PTRS density for the first portion transmitted on the one panel and another PTRS density for the second portion transmitted on the another panel are independent of each other, and where the first portion and the second portion respectively include at least one of: a first set of layers and a second set of layers of the PUSCH for spatial division multiplexing (SDM), where the PTRS density of the first set of layers and the another PTRS density of the second set of layers are associated respectively with two sets of PTRS ports that are independent of each other with respect to at least one of a time domain, a frequency domain, or a sample domain; a first set of RBs and a second set of RBs of the PUSCH for frequency division multiplexing (FDM), where the PTRS density of the first set of RBs and the another PTRS density of the second set of RBs are independent of each other with respect to at least one of a time domain or a frequency domain; a first set of symbols and a second set of symbols of the PUSCH for time division multiplexing (TDM), where the PTRS density of the first set of symbols and the another PTRS density of the second set of symbols are independent of each other with respect to at least one of a time domain or a frequency domain; or a same set of layers, RBs, or symbols of the PUSCH for a system frame number (SFN) implementation, where the PTRS density of the same set of layers, RBs, or symbols and the another PTRS density of the same set of layers, RBs, or symbols are independent of each other with respect to at least one of a time domain or a frequency domain.

Aspect 15 is an apparatus for wireless communication at a network node, including a memory and at least one processor coupled to the memory and, based at least in part on information stored in the memory, the at least one processor is configured to: receive, from a user equipment (UE), information associated with a phase tracking reference signal (PTRS) density for each panel of a set of panels associated with the UE; transmit, for the UE, a configuration associated with the PTRS density for each panel of the set of panels; and communicate with the UE, based on the configuration, downlink data via a physical downlink shared channel (PDSCH) or uplink data via a physical uplink shared channel (PUSCH) based on the PTRS density for one panel in the set of panels, where the PTRS density for the one panel of the set of panels is based on at least one of a modulation and coding scheme (MCS) or a number of scheduled resource blocks (RBs) associated with a PDSCH reception or PUSCH transmission through the one panel.

Aspect 16 is the apparatus of claim 15, where the set of panels is associated with a set of UEs, where the UE includes the set of UEs including a set of relay UEs.

Aspect 17 is the apparatus of aspect 16, where the set of panels includes a plurality of panels, and where each panel is associated with a different UE in the set of UEs.

Aspect 18 is the apparatus of any of aspects 15 to 17, where the information includes a threshold associated with the PTRS density, and where the PTRS density is based on a comparison between the threshold and the MCS or a number of scheduled RBs.

Aspect 19 is the apparatus of aspect 18, where the threshold, associated with the PTRS density that is included in the information, is a UE recommendation threshold for each panel of the set of panels, and where the configuration includes a configured threshold for each panel of the set of panels that is associated with the UE recommendation threshold, and the at least one processor is further configured to: configure the configured threshold for determining the PTRS density based on the UE recommendation threshold.

Aspect 20 is the apparatus of any of aspects 15 to 19, where the PDSCH or the PUSCH communicated via the one panel includes at least a portion of the PDSCH or the PUSCH, respectively.

Aspect 21 is the apparatus of any of aspects 15 to 20, where the at least one processor is further configured to: receive an indication of at least one determined resource element (RE) that is based on the PTRS density; further including at least one of an antenna or a transceiver coupled to the at least one processor, and where to communicate, based on the configuration, the downlink data via the PDSCH or the uplink data via the PUSCH, the at least one processor is configured to: respectively transmit or receive PTRS information in the determined at least one RE via the at least one of the antenna or the transceiver.

Aspect 22 is the apparatus of any of aspects 15 to 21, where each panel in the set of panels is respectively specified by at least one of an explicit panel identifier (ID), a beam group ID, a transmission configuration indicator (TCI) state group ID, an association with a control resource set (CORESET) group, an association with a sounding reference signal (SRS) resource set, one or more port numbers associated with the communication, a code division multiplexed (CDM) group of one or more demodulation reference signal (DMRS) port numbers, an association with a time advance group (TAG) ID, or a radio network temporary ID (RNTI).

Aspect 23 is the apparatus of any of aspects 15 to 22, where the communicated downlink data includes the downlink data via the PDSCH transmitted to the one panel and other downlink data via another PDSCH transmitted to another panel of the set of panels, where the PDSCH and the another PDSCH are fully-overlapping, partially-overlapping, or non-overlapping with respect to each other in at least one of time or frequency, and where the PTRS density for the PDSCH transmitted to the one panel and another PTRS density for the another PDSCH transmitted to the another panel are independent of each other.

Aspect 24 is the apparatus of aspect 23, where the communicated downlink data is based on a multiple downlink control information (multi-DCI) based multiple transmission and reception point (mTRP) PDSCH transmission framework, and where the PDSCH and the another PDSCH are each associated with a corresponding control resource set (CORESET) pool index that respectively represents the one panel and the another panel.

Aspect 25 is the apparatus of any of aspects 15 to 24, where the communicated downlink data includes the downlink data via the PDSCH, where the PDSCH includes a first portion transmitted to the one panel and includes a second portion transmitted to another panel of the set of panels, where the PTRS density for the first portion transmitted to the one panel and another PTRS density for the second portion transmitted to the another panel are independent of each other, and where the first portion and the second portion respectively include at least one of: a first set of layers and a second set of layers of the PDSCH for spatial division multiplexing (SDM), where the PTRS density of the first set of layers and the another PTRS density of the second set of layers are associated respectively with two sets of PTRS ports that are independent of each other with respect to at least one of a time domain or a frequency domain; a first set of RBs and a second set of RBs of the PDSCH for frequency division multiplexing (FDM), where the PTRS density of the first set of RBs and the another PTRS density of the second set of RBs are independent of each other with respect to at least one of a time domain or a frequency domain; a first set of symbols and a second set of symbols of the PDSCH for time division multiplexing (TDM), where the PTRS density of the first set of symbols and the another PTRS density of the second set of symbols are independent of each other with respect to at least one of a time domain or a frequency domain; or a same set of layers, RBs, or symbols of the PDSCH for a system frame number (SFN) implementation, where the PTRS density of the same set of layers, RBs, or symbols and the another PTRS density of the same set of layers, RBs, or symbols are independent of each other with respect to at least one of a time domain or a frequency domain.

Aspect 26 is the apparatus of any of aspects 15 to 22, where the communicated uplink data includes the uplink data via the PUSCH received from the one panel and other uplink data via another PUSCH received from another panel of the set of panels, where the PUSCH and the another PUSCH are fully-overlapping, partially-overlapping, or non-overlapping with respect to each other in at least one of time or frequency, and where the PTRS density for the PUSCH received from the one panel and another PTRS density for the another PUSCH received from the another panel are independent of each other.

Aspect 27 is the apparatus of aspect 26, where the communicating is based on a multiple downlink control information (multi-DCI) based multiple transmission and reception point (mTRP) PUSCH transmission framework, and where the PUSCH and the another PUSCH are each associated with a corresponding control resource set (CORESET) pool index or sounding reference signal (SRS) resource set that respectively represent the one panel and the another panel.

Aspect 28 is the apparatus of any of aspects 15 to 22 and 26 to 27, where the communicated uplink data includes the uplink data via the PUSCH, where the PUSCH includes a first portion received from the one panel and includes a second portion received from another panel of the set of panels, where the PTRS density for the first portion received from the one panel and another PTRS density for the second portion received from the another panel are independent of each other, and where the first portion and the second portion respectively include at least one of: a first set of layers and a second set of layers of the PUSCH for spatial division multiplexing (SDM), where the PTRS density of the first set of layers and the another PTRS density of the second set of layers are associated respectively with two sets of PTRS ports that are independent of each other with respect to at least one of a time domain, a frequency domain, or a sample domain; a first set of RBs and a second set of RBs of the PUSCH for frequency division multiplexing (FDM), where the PTRS density of the first set of RBs and the another PTRS density of the second set of RBs are independent of each other with respect to at least one of a time domain or a frequency domain; a first set of symbols and a second set of symbols of the PUSCH for time division multiplexing (TDM), where the PTRS density of the first set of symbols and the another PTRS density of the second set of symbols are independent of each other with respect to at least one of a time domain or a frequency domain; or a same set of layers, RBs, or symbols of the PUSCH for a system frame number (SFN) implementation, where the PTRS density of the same set of layers, RBs, or symbols and the another PTRS density of the same set of layers, RBs, or symbols are independent of each other with respect to at least one of a time domain or a frequency domain.

Aspect 29 is a method of wireless communication for implementing any of aspects 1 to 28.

Aspect 30 is an apparatus for wireless communication including means for implementing any of aspects 1 to 28.

Aspect 31 is a computer-readable medium (e.g., a non-transitory computer-readable medium) storing computer executable code, the code when executed by at least one processor causes the at least one processor to implement any of aspects 1 to 28.

What is claimed is:

1. A apparatus of wireless communication at a user equipment (UE), comprising:
a memory; and
at least one processor coupled to the memory and, based at least in part on first information stored in the memory, the at least one processor is configured to:
transmit information associated with a phase tracking reference signal (PTRS) density for each panel of a set of panels associated with the UE;
receive, from a network entity, a configuration associated with the PTRS density for each panel of the set of panels; and
communicate, based on the configuration, downlink data via a physical downlink shared channel (PDSCH) or uplink data via a physical uplink shared channel (PUSCH) based on the PTRS density for one panel in the set of panels, wherein the PTRS density for the one panel of the set of panels is based on at least one of a modulation and coding scheme (MCS) or a number of scheduled resource blocks (RBs) associated with a PDSCH reception or PUSCH transmission through the one panel.

2. The apparatus of claim 1, wherein the set of panels is associated with a set of UEs, wherein the UE includes the set of UEs including a set of relay UEs.

3. The apparatus of claim 2, wherein the set of panels includes a plurality of panels, and wherein each panel is associated with a different UE in the set of UEs.

4. The apparatus of claim 1, wherein the information includes a threshold associated with the PTRS density, and wherein the PTRS density is based on a comparison between the threshold and the MCS or a number of scheduled RBs.

5. The apparatus of claim 4, wherein the threshold, associated with the PTRS density that is included in the information, is a UE recommendation threshold for each panel of the set of panels, and wherein the configuration includes a configured threshold for each panel of the set of panels that is associated with the UE recommendation threshold, and the at least one processor is further configured to:
determine the PTRS density according to the configuration based on the comparison.

6. The apparatus of claim 1, wherein the PDSCH or the PUSCH communicated via the one panel includes at least a portion of the PDSCH or the PUSCH, respectively.

7. The apparatus of claim 1, wherein the at least one processor is further configured to:
determine at least one resource element (RE) based on the PTRS density; and
wherein to communicate, based on the configuration, the downlink data via the PDSCH or the uplink data via the PUSCH, the at least one processor is configured to: respectively receive or transmit PTRS information in the determined at least one RE.

8. The apparatus of claim 1, wherein each panel in the set of panels is respectively specified by at least one of an explicit panel identifier (ID), a beam group ID, a transmission configuration indicator (TCI) state group ID, an association with a control resource set (CORESET) group, an association with a sounding reference signal (SRS) resource set, one or more port numbers associated with the communication, a code division multiplexed (CDM) group of one or more demodulation reference signal (DMRS) port numbers, an association with a time advance group (TAG) ID, or a radio network temporary ID (RNTI).

9. The apparatus of claim 1, wherein the communicated downlink data includes the downlink data via the PDSCH received on the one panel and other downlink data via another PDSCH received on another panel of the set of panels, wherein the PDSCH and the another PDSCH are fully-overlapping, partially-overlapping, or non-overlapping with respect to each other in at least one of time or frequency, and wherein the PTRS density for the PDSCH received on the one panel and another PTRS density for the another PDSCH received on the another panel are independent of each other.

10. The apparatus of claim 9, wherein the communicated downlink data is based on a multiple downlink control information (multi-DCI) based multiple transmission and reception point (mTRP) PDSCH transmission framework, and wherein the PDSCH and the another PDSCH are each associated with a corresponding control resource set (CORESET) pool index that respectively represents the one panel and the another panel.

11. The apparatus of claim 1, wherein the communicated downlink data includes the downlink data via the PDSCH, wherein the PDSCH includes a first portion received on the one panel and includes a second portion received on another panel of the set of panels, wherein the PTRS density for the first portion received on the one panel and another PTRS density for the second portion received on the another panel are independent of each other, and wherein the first portion and the second portion respectively include at least one of:
a first set of layers and a second set of layers of the PDSCH for spatial division multiplexing (SDM), wherein the PTRS density of the first set of layers and the another PTRS density of the second set of layers are associated respectively with two sets of PTRS ports that are independent of each other with respect to at least one of a time domain or a frequency domain;
a first set of RBs and a second set of RBs of the PDSCH for frequency division multiplexing (FDM), wherein the PTRS density of the first set of RBs and the another PTRS density of the second set of RBs are independent of each other with respect to at least one of the time domain or the frequency domain;
a first set of symbols and a second set of symbols of the PDSCH for time division multiplexing (TDM), wherein the PTRS density of the first set of symbols and the another PTRS density of the second set of symbols are independent of each other with respect to at least one of the time domain or the frequency domain; or
a same set of layers, RBs, or symbols of the PDSCH for a system frame number (SFN) implementation, wherein the PTRS density of the same set of layers, RBs, or symbols and the another PTRS density of the same set of layers, RBs, or symbols are independent of each other with respect to at least one of the time domain or the frequency domain.

12. The apparatus of claim 1, wherein the communicated uplink data includes the uplink data via the PUSCH transmitted on the one panel and other uplink data via another PUSCH transmitted on another panel of the set of panels, wherein the PUSCH and the another PUSCH are fully-overlapping, partially-overlapping, or non-overlapping with respect to each other in at least one of time or frequency, and wherein the PTRS density for the PUSCH transmitted on the one panel and another PTRS density for the another PUSCH transmitted on the another panel are independent of each other.

13. The apparatus of claim 12, wherein the communicating is based on a multiple downlink control information (multi-DCI) based multiple transmission and reception point (mTRP) PUSCH transmission framework, and wherein the PUSCH and the another PUSCH are each associated with a corresponding control resource set (CORESET) pool index or sounding reference signal (SRS) resource set that respectively represent the one panel and the another panel.

14. The apparatus of claim 1, wherein the communicated uplink data includes the uplink data via the PUSCH, wherein the PUSCH includes a first portion transmitted on the one panel and includes a second portion transmitted on another panel of the set of panels, wherein the PTRS density for the first portion transmitted on the one panel and another PTRS density for the second portion transmitted on the another panel are independent of each other, and wherein the first portion and the second portion respectively include at least one of:
a first set of layers and a second set of layers of the PUSCH for spatial division multiplexing (SDM), wherein the PTRS density of the first set of layers and the another PTRS density of the second set of layers are associated respectively with two sets of PTRS ports that are independent of each other with respect to at least one of a time domain, a frequency domain, or a sample domain;
a first set of RBs and a second set of RBs of the PUSCH for frequency division multiplexing (FDM), wherein the PTRS density of the first set of RBs and the another PTRS density of the second set of RBs are independent of each other with respect to at least one of the time domain or the frequency domain;
a first set of symbols and a second set of symbols of the PUSCH for time division multiplexing (TDM), wherein the PTRS density of the first set of symbols and the another PTRS density of the second set of symbols are independent of each other with respect to at least one of the time domain or the frequency domain; or
a same set of layers, RBs, or symbols of the PUSCH for a system frame number (SFN) implementation, wherein the PTRS density of the same set of layers, RBs, or symbols and the another PTRS density of the same set of layers, RBs, or symbols are independent of each other with respect to at least one of the time domain or the frequency domain.

15. A apparatus of wireless communication at a network entity, comprising:
a memory; and
at least one processor coupled to the memory and, based at least in part on first information stored in the memory, the at least one processor is configured to:
receive, from a user equipment (UE), information associated with a phase tracking reference signal (PTRS) density for each panel of a set of panels associated with the UE;
transmit, for the UE, a configuration associated with the PTRS density for each panel of the set of panels; and
communicate with the UE, based on the configuration, downlink data via a physical downlink shared channel (PDSCH) or uplink data via a physical uplink shared channel (PUSCH) based on the PTRS density for one panel in the set of panels, wherein the PTRS density for the one panel of the set of panels is based on at least one of a modulation and coding scheme (MCS) or a number of scheduled resource blocks (RBs) associated with a PDSCH reception or PUSCH transmission through the one panel.

16. The apparatus of claim 15, wherein the set of panels is associated with a set of UEs, wherein the UE includes the set of UEs including a set of relay UEs.

17. The apparatus of claim 16, wherein the set of panels includes a plurality of panels, and wherein each panel is associated with a different UE in the set of UEs.

18. The apparatus of claim 15, wherein the information includes a threshold associated with the PTRS density, and wherein the PTRS density is based on a comparison between the threshold and the MCS or a number of scheduled RBs.

19. The apparatus of claim 18, wherein the threshold, associated with the PTRS density that is included in the information, is a UE recommendation threshold for each panel of the set of panels, and wherein the configuration includes a configured threshold for each panel of the set of panels that is associated with the UE recommendation threshold, and the at least one processor is further configured to:
configure the configured threshold for determining the PTRS density based on the UE recommendation threshold.

20. The apparatus of claim 15, wherein the PDSCH or the PUSCH communicated via the one panel includes at least a portion of the PDSCH or the PUSCH, respectively.

21. The apparatus of claim 15, wherein the at least one processor is further configured to:
receive an indication of at least one determined resource element (RE) that is based on the PTRS density;
wherein to communicate, based on the configuration, the downlink data via the PDSCH or the uplink data via the PUSCH, the at least one processor is configured to: respectively transmit or receive PTRS information in the determined at least one RE.

22. The apparatus of claim 15, wherein each panel in the set of panels is respectively specified by at least one of an explicit panel identifier (ID), a beam group ID, a transmission configuration indicator (TCI) state group ID, an association with a control resource set (CORESET) group, an association with a sounding reference signal (SRS) resource set, one or more port numbers associated with the communication, a code division multiplexed (CDM) group of one or more demodulation reference signal (DMRS) port numbers, an association with a time advance group (TAG) ID, or a radio network temporary ID (RNTI).

23. The apparatus of claim 15, wherein the communicated downlink data includes the downlink data via the PDSCH transmitted to the one panel and other downlink data via another PDSCH transmitted to another panel of the set of panels, wherein the PDSCH and the another PDSCH are fully-overlapping, partially-overlapping, or non-overlapping with respect to each other in at least one of time or frequency, and wherein the PTRS density for the PDSCH transmitted to the one panel and another PTRS density for the another PDSCH transmitted to the another panel are independent of each other.

24. The apparatus of claim 23, wherein the communicated downlink data is based on a multiple downlink control information (multi-DCI) based multiple transmission and reception point (mTRP) PDSCH transmission framework, and wherein the PDSCH and the another PDSCH are each associated with a corresponding control resource set (CORESET) pool index that respectively represents the one panel and the another panel.

25. The apparatus of claim 15, wherein the communicated downlink data includes the downlink data via the PDSCH, wherein the PDSCH includes a first portion transmitted to the one panel and includes a second portion transmitted to another panel of the set of panels, wherein the PTRS density for the first portion transmitted to the one panel and another PTRS density for the second portion transmitted to the another panel are independent of each other, and wherein the first portion and the second portion respectively include at least one of:
a first set of layers and a second set of layers of the PDSCH for spatial division multiplexing (SDM), wherein the PTRS density of the first set of layers and the another PTRS density of the second set of layers are associated respectively with two sets of PTRS ports that are independent of each other with respect to at least one of a time domain or a frequency domain;
a first set of RBs and a second set of RBs of the PDSCH for frequency division multiplexing (FDM), wherein the PTRS density of the first set of RBs and the another PTRS density of the second set of RBs are independent of each other with respect to at least one of the time domain or the frequency domain;
a first set of symbols and a second set of symbols of the PDSCH for time division multiplexing (TDM), wherein the PTRS density of the first set of symbols and the another PTRS density of the second set of symbols are independent of each other with respect to at least one of the time domain or the frequency domain; or
a same set of layers, RBs, or symbols of the PDSCH for a system frame number (SFN) implementation, wherein the PTRS density of the same set of layers, RBs, or symbols and the another PTRS density of the same set of layers, RBs, or symbols are independent of each other with respect to at least one of the time domain or the frequency domain.

26. The apparatus of claim 15, wherein the communicated uplink data includes the uplink data via the PUSCH received from the one panel and other uplink data via another PUSCH received from another panel of the set of panels, wherein the PUSCH and the another PUSCH are fully-overlapping, partially-overlapping, or non-overlapping with respect to each other in at least one of time or frequency, and wherein the PTRS density for the PUSCH received from the one panel and another PTRS density for the another PUSCH received from the another panel are independent of each other.

27. The apparatus of claim 26, wherein the communicating is based on a multiple downlink control information (multi-DCI) based multiple transmission and reception point (mTRP) PUSCH transmission framework, and wherein the PUSCH and the another PUSCH are each associated with a corresponding control resource set (CORESET) pool index or sounding reference signal (SRS) resource set that respectively represent the one panel and the another panel.

28. The apparatus of claim 15, wherein the communicated uplink data includes the uplink data via the PUSCH, wherein the PUSCH includes a first portion received from the one panel and includes a second portion received from another panel of the set of panels, wherein the PTRS density for the first portion received from the one panel and another PTRS density for the second portion received from the another panel are independent of each other, and wherein the first portion and the second portion respectively include at least one of:
a first set of layers and a second set of layers of the PUSCH for spatial division multiplexing (SDM), wherein the PTRS density of the first set of layers and the another PTRS density of the second set of layers are associated respectively with two sets of PTRS ports that are independent of each other with respect to at least one of a time domain, a frequency domain, or a sample domain;
a first set of RBs and a second set of RBs of the PUSCH for frequency division multiplexing (FDM), wherein the PTRS density of the first set of RBs and the another PTRS density of the second set of RBs are independent of each other with respect to at least one of the time domain or the frequency domain;
a first set of symbols and a second set of symbols of the PUSCH for time division multiplexing (TDM), wherein the PTRS density of the first set of symbols and the another PTRS density of the second set of symbols are independent of each other with respect to at least one of the time domain or the frequency domain; or
a same set of layers, RBs, or symbols of the PUSCH for a system frame number (SFN) implementation, wherein the PTRS density of the same set of layers, RBs, or symbols and the another PTRS density of the same set of layers, RBs, or symbols are independent of each other with respect to at least one of the time domain or the frequency domain.

29. A method of wireless communication at a user equipment (UE), comprising:
transmitting information associated with a phase tracking reference signal (PTRS) density for each panel of a set of panels associated with the UE;
receiving, from a network entity, a configuration associated with the PTRS density for each panel of the set of panels; and
communicating, based on the configuration, downlink data via a physical downlink shared channel (PDSCH) or uplink data via a physical uplink shared channel (PUSCH) based on the PTRS density for one panel in the set of panels, wherein the PTRS density for the one panel of the set of panels is based on at least one of a modulation and coding scheme (MCS) or a number of scheduled resource blocks (RBs) associated with a PDSCH reception or PUSCH transmission through the one panel.

30. A method of wireless communication at a network entity, comprising:
receiving, from a user equipment (UE), information associated with a phase tracking reference signal (PTRS) density for each panel of a set of panels associated with the UE;
transmitting, for the UE, a configuration associated with the PTRS density for each panel of the set of panels; and
communicating with the UE, based on the configuration, downlink data via a physical downlink shared channel (PDSCH) or uplink data via a physical uplink shared channel (PUSCH) based on the PTRS density for one panel in the set of panels, wherein the PTRS density for the one panel of the set of panels is based on at least one of a modulation and coding scheme (MCS) or a number of scheduled resource blocks (RBs) associated with a PDSCH reception or PUSCH transmission through the one panel.
